(19) United States
(12) Patent Application Publication
(10) Pub. No.: US 2016/0088065 A1
(43) Pub. Date: Mar. 24, 2016

(54) DEMANDED DOWNLOADS BY LINKS

(71) Applicant: VARONIS SYSTEMS, LTD., Herzliya (IL)

(72) Inventors: Yakov FAITELSON, New York, NY (US); Ohad Korkus, New York, NY (US); Ophir Kretzer-Katzir, Tenafly, NJ (US)

(73) Assignee: VARONIS SYSTEMS, LTD.

(21) Appl. No.: 14/492,024

(22) Filed: Sep. 21, 2014

(51) Int. Cl. H04L 29/08

(52) U.S. Cl. CPC H04L 67/10; H04L 67/025

(57) ABSTRACT

A method for handling data of a computerized system at a remote computer linked to the computerized system, the method comprising subject to applying an at least one rule fetching from the computerized system to the remote computer a stub of an object of the computerized system generated according to the location of the object, actuating the stub, thereby downloading a copy of the object from the computerized system to the remote computer, and consequent to a modification of the copy of the object in the remote computer, updating the object in the computerized system according the modification.

### BACKGROUND

The present disclosure generally relates to links to data, and more specifically to links as stubs.

Using links or stubs for accessing data objects is known in the art, for example, as in http://en.wikipedia.org/wiki/Stub_file or in http://encyclopedia2.thefreedictionary.com/HSM.

### SUMMARY

One exemplary embodiment of the disclosed subject matter is method for handling data of a computerized system at a remote computer linked to the computerized system, the method comprising subject to applying an at least one rule fetching from the computerized system to the remote computer a stub of an object of the computerized system generated according to the location of the object, actuating the stub, thereby downloading a copy of the object from the computerized system to the remote computer, and consequent to a modification of the copy of the object in the remote computer, updating the object in the computerized system according the modification.

### BRIEF DESCRIPTION OF THE DRAWINGS

Some non-limiting exemplary embodiments or features of the disclosed subject matter are illustrated in the following drawings.

Identical or duplicate or equivalent or similar structures, elements, or parts that appear in one or more drawings are generally labeled with the same reference numeral, optionally with an additional letter or letters to distinguish between similar entities or variants of entities, and may not be repeatedly labeled and/or described.

References to previously presented elements are implied without necessarily further citing the drawing or description in which they appear.

FIG. 1A schematically illustrates a computerized system comprising one or more computers, illustrated as three computers representing any number of computers, according to exemplary embodiments of the disclosed subject matter;

FIG. 1B schematically illustrates the computerized system of FIG. 1A with a remote computer linked to the computerized system, according to exemplary embodiments of the disclosed subject matter;

FIG. 2 schematically illustrates stubs in a client computer and objects of computerized system 100 as target objects thereof, according to exemplary embodiments of the disclosed subject matter; and

FIG. 3 outlines operations in using stubs at a computer remote from a computerized system, according to exemplary embodiments of the disclosed subject matter.

### DETAILED DESCRIPTION

In the context of some embodiments of the present disclosure, without limiting, a stub of an object implies a data entity that facilities accessing and/or having a link to the object, such as a URL. The object is also referred to as a target object.

By and large or statistically, size of a stub of an object is insignificantly small or negligible relative to size of a target object thereof. For example, a stub generally being about 100 bytes or less or up to about 1000 bytes, whereas an object, excluding exceptionally small objects, is in an order of magnitude of 10⁴-10⁷ bytes or higher. For brevity, unless otherwise specified, a stub of an object is also referred to as a stub.

In the context of the present disclosure, without limiting, the term ‘computerized system’ implies a system comprising a plurality of computing apparatuses, such as computers, communicating therebetween and having and/or sharing and/or communicating with a data storage device. The data storage device is also referred to as ‘data storage’ or ‘storage’.

Generally, without limiting, a computerized system comprises several computers in a range between about 10 computers to about 1000 computers or more. Optionally, a computerized system comprises less than 10 computers, not precluding having one computer as, for example, a mainframe computer.

In some embodiments or cases, the computerized system belongs and/or affiliated with an organization such as a business.

For brevity, referring to an operation of and/or by a computerized system implies an operation of and/or by one or more components and/or of the computerized system, such as by one or more computers of the computerized system.

In the context of the present disclosure, without limiting, the term ‘object’ implies a data element, such as a folder, a file or a database.

In the context of the present disclosure, without limiting, attributes or metadata of an object imply an at least one characteristic and/or property of the object such as permission to access the object, content classification of the object, sensitivity or confidentiality of the object, type of the object and/or other metadata such as a creator of the objects or an owner of objects, or tags or flags or notes regarding the object.

In the context of the present disclosure, without limiting, the term ‘remote computer’ implies a computer linkable and/or linked to the computerized system such as to a network operative in the computerized system or to a component of the computerized system such as to a computer thereof. It is noted that a remote computer may be any computerized apparatus including also a portable apparatus such as a cellular phone or a tablet. In some embodiments or cases, a remote computer may or may not belong to the computerized system and/or to an organization thereof.

Further in the context of the present disclosure, the qualifier ‘remote’ pertains and/or relates to a remote computer. For example, a ‘remote program’ implies a program operable and/or operating on a remote computer and/or in conjunction with the remote computer such as a script in a Web browser or a program in the computerized system accessible by the remote computer.

In the context of the present disclosure, without limiting, the term ‘client’ implies a person or a user or an operator operating a remote computer, or any entity operating on behalf of the client such as an individual or a program. Accordingly, the term ‘client computer’ implies also a remote computer.

It is noted that generally, though not strictly necessary, storage capacity at a remote computer is smaller and/or limited relative to the storage of the computerized system.

Generally, though not strictly necessary, in the context of the present disclosure the client does not belong to the computerized system and/or to an organization thereof. For example, a client affiliated with an organization disparate from the organization of the computerized system and operating a remote computer outside of the computerized system.

In the context of some embodiments of the present disclosure, without limiting, the term collaboratable implies a property or a quality of an object, indicating ability or capacity to participate in collaboration or a collaborated operation with one or more parties including one or more parties to which the object does not belong and/or relates with. Such collaboration may be implemented by accessing and/or updating and/or amending the content, metadata and/or any characteristic of at least a portion of the object.

In the context of some embodiments of the present disclosure, without limiting, the term ‘collaborativity’ implies a quality or state of being collaboratable as related to an object and, likewise, the term ‘collaboratability’ implies capability and/or capacity for collaboration.

In the context of the present disclosure, without limiting, the term rule implies a construct comprising conditions concerning entities such as objects and/or properties of objects such as metadata thereof and/or collaborativity of objects such as indicated by a True/False value.

In the context of the present disclosure, without limiting, the term ‘subject to’ as subject to a rule implies dependent or conditional by a rule in case the rule is applied.

The terms cited above denote also inflections and conjugates thereof.

One technical problem dealt by the disclosed subject matter is reducing storage requirement and/or processing and communication load in a remote computer having to download thereto objects of a computerized system, such as for accessing the objects and/or for other operations such as collaboration with the objects.

One technical solution according to the disclosed subject matter is downloading or fetching to the remote computer stubs of objects of the computerized system instead of the objects per se. Downloading the stubs which are significantly smaller than the target objects rather than of the target objects is faster in terms of communication and processing and requires significantly less storage space.

Downloading or fetching the stubs may be upon request by the remote computer and/or upon determination by the computerized system.

Once the stubs are loaded into the remote computer, the client may actuate or trigger a stub such as by double-click with a mouse or selecting and using a keyboard key such as Enter or by a double-touch on a touchscreen. Responsively to actuating a stub a dedicated program installed in the remote computer, referred to also as a client program, obtains the link or any other data of the stub that facilitates downloading of the target object, and according to which downloads the target object to the remote computer.

Another technical problem dealt by the disclosed subject matter is controlling and/or managing downloading of objects of a computerized system to a remote computer, such as for accessing the objects and/or for other operations such as collaboration with the objects.

Once a stub is actuated, such as described above, the client program applies and/or operates one or more rules according to which downloading of a target object is decided. For example, the applied rule may prohibit downloading of a target object due to properties and/or metadata of the target object, such as due to sensitivity of the target object as classified. Thus, the rules practically filter which target objects are allowed to be downloaded.

In some embodiments, according to the rule, the client program looks up for the properties or metadata of the target object. In some embodiments, the properties or metadata are looked up in the computerized system. Optionally or alternatively, relevant properties or metadata of the target object are incorporated and/or linked to the stub and the client program looks up in the stub and/or via the link therein.

A potential technical effect of the disclosed subject matter is effectively managing downloading of object s to a remote computer in terms of storage space and communication bandwidth and execution load.

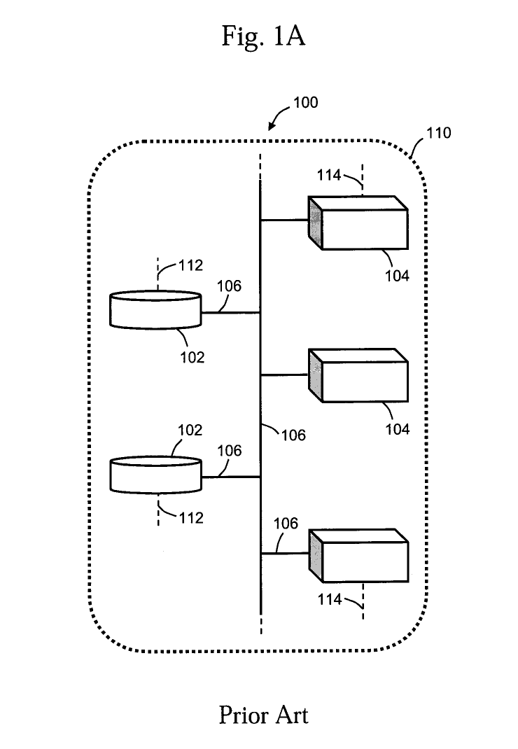

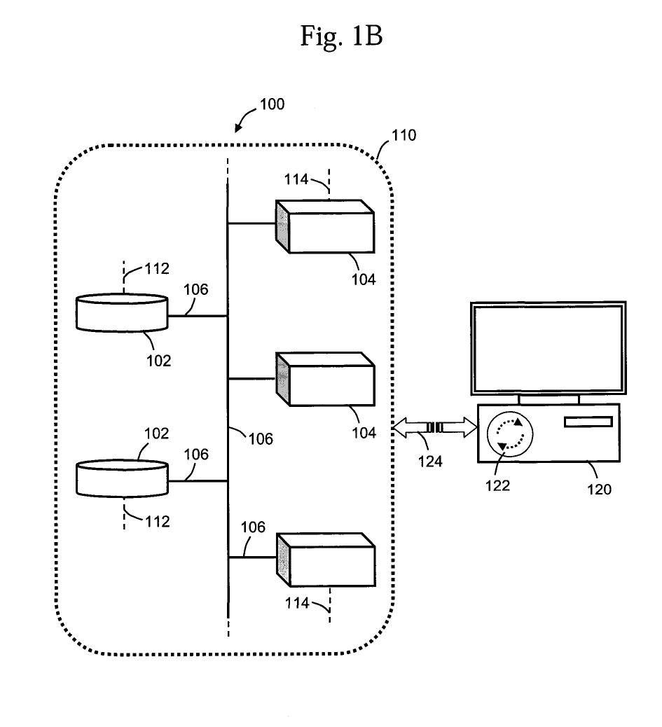

FIG. 1A schematically illustrates, according to exemplary embodiments of the disclosed subject matter, a computerized system 100, designated by a dotted frame 110, comprising one or more computers, illustrated as three instances of a computer 104, representing any number of computer 104, as indicated by dashed lines 114.

Computerized system 100 further comprises one or more data storage devices, illustrated as two instances of a data storage device 102, representing any number of data storage device 102, as indicated by dashed lines 112. Data storage device 102 generally stores objects or data entities such as files or database records or users definitions or similar elements collectively referred to also as objects. Data storage device 102 optionally stored an index or part thereof of computerized system 100.

Computerized system 100 is configured to exchange data with devices external to computerized system 100 by communications facilities comprised therein.

The instances of computer 104 are connected or linked or coupled therebetween and to the instances of data storage device 102, the connection or linkage illustrated and represented by a network 106.

FIG. 1B schematically illustrates, according to exemplary embodiments of the disclosed subject matter, computerized system 100 with a client computer 120 linked to computerized system 100, representing any number of client computer 120.

Client computer 120 is connected or linked to computerized system 100 by any communication facility or facilities comprised in computerized system 100 and/or client computer 120 as illustrated schematically by a double-ended arrow 124 representing also a two-directional data flow between computerized system 100 and client computer 120. For example, client computer 120 is linkable with computerized system 100 via network 106 and/or one of computer 104,

Client computer 120 comprises an add-on program referred to also as client program, schematically illustrated as a client program 122, configured for and operative for downloading target objects of stubs and, further, optionally, for fetching and/or looking up metadata of the target objects, and, further, optionally, for downloading stubs of target objects and, further, optionally, for updating target objects in computerized system responsive to operations on target objects, or copies thereof, in client computer 120.

In some embodiments, client program 122 is not installed in client computer 120 but, rather, for example, client program 122 is installed or operative in computerized system 100 or operative as a script in a Web browser. Optionally, a rudimentary program (not shown) is used to communicate and/or operate with client program 122

In some embodiments, client program 122 is further configured for applying or operating one or more rules that govern operational possibilities and/or capabilities, as described below.

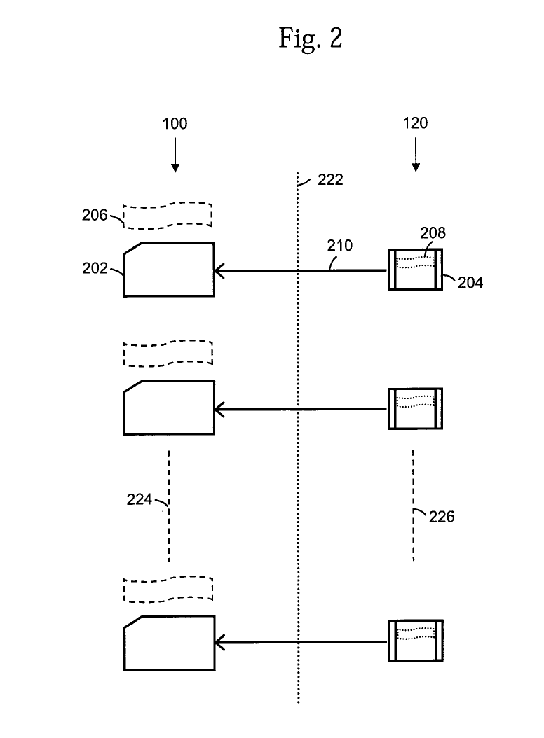

FIG. 2 schematically illustrates instances of a stub 204 in client computer 120 and objects of computerized system 100 as corresponding instances of a target object 202, according to exemplary embodiments of the disclosed subject matter. For clarity a dotted line 222 separates between computerized system 100 and client computer 120.

The instances of target object 202 and correspondingly the instances of stub 204 represent any number of target object 202 and irrespectively any number of stub 204, as indicated, respectively, by a dashed line 224 and a dashed line 226.

The relation between stub 204 and target object 202 is indicated schematically by an arrow 210 that represents a link between stub 204 and target object 202.

Generally, target object 202 has corresponding metadata, represented schematically by as metadata 206. In some embodiments, metadata 206 and/or part thereof is included in stub 204, as represented schematically by as metadata 208.

In some embodiments, stub 204 is named as target object 202, where each having different types. Optionally, stub 204 is named such as to reflect the correspondence thereof with target object 202. For example, adding a prefix ‘stub of . . . ’ or providing a description of the relation of stub 204 to target object 202.

It is emphasized that, apart from exceptional cases, generally stub 204, optionally with metadata 208, is smaller in size relative to target object 202 even by orders of magnitude.

A general non-limiting presentation of practicing the present disclosure is given below, outlining exemplary practice of embodiments of the present disclosure and providing a constructive basis for variant and/or alternative and/or divergent embodiments.

Stub 204 is generated based on the location of target object 202 in computerized system 100 and transferred or fetched to client computer 120, optionally with metadata 208. For example, stub 204 is generated based on the path of target object 202 in computerized system 100 possibly with an address or link for reaching at computerized system 100, such as an IP address thereof, where, optionally, metadata 208 is formed and/or generated based on metadata 206.

In some embodiments, the transfer is initiated by a client operating on client computer 120, for example, when the client wishes to access target object 202 or to collaborate with target object 202. Optionally or additionally, the transfer is initiated by and/or via computerized system 100, for example, when a business manager of an organization of computerized system 100 requires to collaborate target object 202 with a client. Further, in some embodiments, client program 122 is invoked for transferring stub 204 to client computer 120.

Obviously, the transfer can be carried out provided that client computer 120 is linked to computerized system 100, yet subsequent to the transfer client computer 120 may be unlinked from computerized system 100 until possibly further data transfers are required. In some embodiments, when a transfer of data between computerized system 100 and client computer 120 is necessary but client computer 120 is not linked with computerized system 100, information to that effect is set in client computer 120. Consequently, when client computer 120 is linked to computerized system 100 the transfer is automatically and/or manually initiated.

For brevity and clarity and by way of example, in the following description and unless otherwise specified, it is assumed that client computer 120 is linked to computerized system 100.

In some embodiments, stub 204 is transferred to a dedicated and/or a preset space on client computer 120 such as one or more folders, referred to also as a client workspace or workspace.

Once stub 204 is stored in client computer 120, when it is required to operate on or manipulate target object 202, stub 204 is actuated or triggered. Consequently, client program 122 is activated and using the data in stub 204, such as a link between stub 204 and target object 202, downloads target object 202 from computerized system 100 to client computer 120. In some embodiments, target object 202 is downloaded into the client workspace.

In some embodiments, stub 204 is manually triggered. For example, the client selects and/or points at stub 204 on a screen and double-clicks on stub 204 or presses a suitable key of a keyboard.

It is noted that target object 202 is downloaded to client computer 120 generally a copy of target object 202 is downloaded. Thus, unless otherwise specified, referring to target object 202 at client computer 120 implies referring to a copy of target object 202.

In some embodiments, the client may operate on or manipulate target object 202 such as accessing and/or modifying target object 202. In some embodiments, after operation on target object 202 is completed, client program 122 may be invoked, such as by a soft control as a screen button and/or hard control as a key of a keyboard, and based on stub 204 client program 122 updates and/or synchronizes target object 202 in computerized system 100. Accordingly, target object 202 in computerized system 100 reflects possible modifications performed on target object 202 at client computer 120. Thus, target object 202 may be collaborated with. For example, a plurality of client computer 120 may operate on and/or modify target object 202 as well as parties or users of computerized system 100.

In some embodiments, when operation on target object 202 is accomplished and target object 202 is updated and/or synchronized with computerized system 100, target object 202 may be discarded from client computer 120, optionally retaining stub 204. Thus, the generally limited storage capacity at client computer 120 is freed of superfluous data. In some embodiments, discarding of target object 202 from client computer 120 is performed automatically such as by a activating a control to that effect, or, optionally, discarding of target object 202 is done manually.

It is noted that, in some embodiments, target object 202 is downloaded to client computer 120 with some restrictions as to operating on target object 202. For example, in case target object 202 is classified as protected then target object 202 is downloaded in a read-only status. The classification or other metadata of target object 202 may be judged based on metadata 206 and/or metadata 208.

It is noted that the description with respect to stub 204 and corresponding target object 202 applies as well to a plurality thereof or any number thereof.

Thus, according to the description above, even that client computer 120 holds stubs of at least potentially required target objects rather than the target objects themselves, yet the functionally relative to holding the actual target objects is practically not affected or negligibly affected while space in the generally limited capacity of the storage at client computer 120 is saved.

In some embodiments, predefined and/or determined one or more rules, collectively referred to also as rules, are constructed and operative to control and/or modify handling of downloading target objects from computerized system 100 to client computer 120 and/or operations on and/or with target object 202.

The rules are constructed in any suitable manner with conditions and resultant effects regarding the stubs and/or the corresponding target objects and/or handling thereof. The rules are generally, though not limited to, based on metadata 206 and/or metadata 208.

The rules are applied responsive to downloading a stub and/or attempting to downloading a stub and/or to actuating a stub and/or operating on target objects.

In some embodiments, the rules are installed in client computer 120 and operated and/or applied by client program 122. For example, when a stub is fetched from computerized system 100, a rule checks by metadata 206 and/or metadata 208 whether the corresponding target object is restricted or locked, and if so client program 122 blocks and/or discard the stub, disabling access to the target object at client computer 120.

Optionally or alternatively, the rules are installed in computerized system 100, thereby affecting fetching of stubs and/or downloading of target objects. For example, according to metadata 206 a rule may block or disable fetching of a stub and/or downloading of a target object such as to client computer 120. Optionally or additionally, when the rules are installed in computerized system 100 yet the rules are carried out and/or facilitated by client program 122.

For brevity and without limiting, by way of example it is assumed that the rules are installed in client computer 120 and operated and/or applied by client program 122.

Thus, for example, when a stub is actuated, a rule checks by metadata 206 and/or metadata 208 whether the corresponding target object is classified as sensitive, and if so client program 122 marks or sets the downloaded target object to the effect that the target object cannot be saved permanently on client computer 120, so consequently, for example, client program 122 would discard the target objects responsive to saving.

As another example, a rule checks by metadata 206 and/or metadata 208 whether the stub is allowed to be activated, and if not the stub actuation is prevented, such as by client program 122.

As another example, when a stub is fetched, a rule checks by metadata 206 and/or metadata 208 whether the corresponding target object is collaboratable, and if not so client program 122 would set the target object at client computer 120 as read-only, thereby the target object would be restricted to modifications.

As yet another example, when target object 202 is modified, provided that amendments are allowed, a rule checks by metadata 206 and/or metadata 208 whether information to that effect has to be recorded. If so, an audit trail or another construct that reflects the modification of the modifications is generated, and sent to computerized system 100 such as when client program 122 updates and/or synchronizes target object 202 in computerized system 100.

As yet another example, when target object 202 is modified, provided that amendments are allowed, a rule checks by metadata 206 and/or metadata 208 whether client program 122 may update and/or synchronize target object 202 in computerized system 100. If not so the modifications might be local on client computer 120 but not forwarded or synchronized in computerized system 100.

Accordingly, handling of stubs and target objects, including optionally manipulating or modification of target objects in client computer 120 is subject to the rules.

An exemplary non-limiting rule is illustrated figuratively in Table-1 below.

TABLE 1

| | |
|---|---|
| Classification of a target object of a stub = | Permanent save = False |
| ‘sensitive’ | |
| Classification of a target object of a stub = | Discard stub = True |
| ‘restricted’ | |
| Classification of a target object of a stub = | Discard stub = True |
| ‘restricted’ | |
| Classification of a target object of a stub = | Stub actuation = False |
| ‘blocked’ | |
| Collaboration of a target object of a stub = | Amendment = False |
| False | |

It is noted that the rule of Table-1 may, in some embodiments, be considered and/or implemented as three separated rules and/or in any combination thereof.

The rule may be constructed or coded in any appropriate manner, such as a script, an executable program or as a lookup table. Results or outcomes of the rules are set for the respective item, such as a stub or an object, for example, in metadata 208 or in an attribute thereof or in a data structure of client computer 120.

It is clarified that in case fetching of a stub is disabled or blocked, any subsequent operations depending on the stub are omitted. Likewise, in case actuation of a stub is disabled or blocked, the corresponding target object is not loaded and thus any operation regarding the target object is omitted. Further likewise, in case operations on the target object are disabled or blocked, updating the target object in computerized system 100 is omitted as it in fact superfluous.

In some embodiments, in case the size of a target object of a stub is not larger than the size of the stub and/or is within a given range, then the target object is downloaded instead of the stub, provided that the target object is acceptable by the rules and/or any other restriction such as whether the target object is allowed to be downloaded to client computer 120 and/or any remote computer.

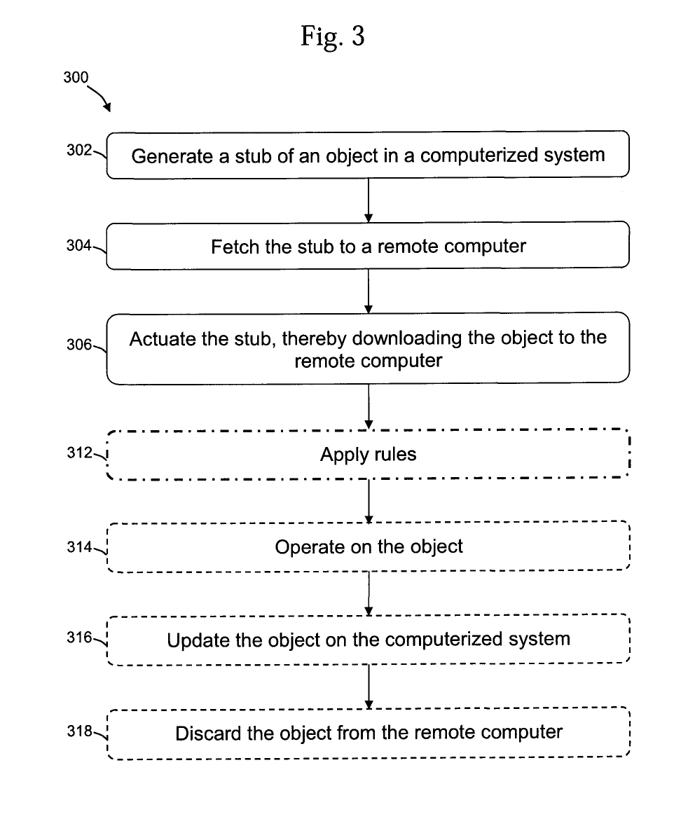

FIG. 3 outlines operations 300 in using stubs at a computer remote from a computerized system, according to exemplary embodiments of the disclosed subject matter.

In operation 302 a stub of an object in a computerized system is generated, such as comprising a link to the object. Optionally, the stub comprises at least a part of the metadata of the object. The stub is generated according to the location of the object in the computerized system.

In operation 304 the stub is fetched or downloaded to a remote computer. In some embodiments, the stub may be fetched from the computerized system responsive to a request by the remote computer, thereby the computerized system generates the stub and downloads it to the remote computer. Optionally or alternatively, the stub may be fetched by a program operating in the remote computer and interacts with the computerized system. Further optionally or alternatively, the stub may be downloaded to the remote computer by the computerized system such as based upon a request of a party of the computerized system, for example, a business owner of the computerized system or an organization thereof.

In operation 306 the stub is actuated, thereby the object as a copy thereof is downloaded to the remote computer such as by using the link to the object. Generally the actuation of a stub is carried out by a user of the remote computer.

In operation 312, optionally, one or more rules are applied according to which fetching of the stub and/or downloading of the object and/or optional operations on the object are decided or controlled.

In operation 314 the object is optionally operated upon possibly under restrictions applied by the one or more rules. In some embodiments, the operation on the object comprises modification of the object.

In operation 316, optionally and depending if the object was modified, the object is updated and/or synchronized the computerized system according to the modification to the object carried out on the remote computer.

In operation 318, optionally, when operations on the object are done with, if any, the object is discarded from the remote computer.

There is thus provided according to the present disclosure a method for handling data of a computerized system at a remote computer linked to the computerized system, the method comprising subject to applying an at least one rule fetching from the computerized system to the remote computer a stub of an object of the computerized system generated according to the location of the object, actuating the stub, thereby downloading a copy of the object from the computerized system to the remote computer, and consequent to a modification of the copy of the object in the remote computer, updating the object in the computerized system according the modification.

In some embodiments, the method is facilitated by a program installed in the remote computer.

In some embodiments, the stub comprises at least a part of metadata of the object of the computerized system.

In some embodiments, the at least one rule is based on metadata of the object of the computerized system.

In some embodiments, subject to the at least one rule fetching the stub is disabled and thus actuating the stub and updating the object in the computerized system consequent to the modification of the copy of the object are omitted.

In some embodiments, subject to the at least one rule actuating the stub is disabled and thus updating the object in the computerized system consequent to the modification of the copy of the object is omitted.

In some embodiments, subject to the at least one rule the modification of the copy of the object is disabled and thus updating the object in the computerized system omitted.

In some embodiments, the at least one rule is installed in the remote computer.

In some embodiments, the applying of the at least one rule is carried out by the program installed in the remote computer.

In some embodiments, the at least one rule is installed in the computerized system.

In some embodiments, the applying of the at least one rule is facilitated by the program installed in the remote computer.

In some embodiments, consequent to updating the object in the computerized system the copy of the object is discarded from the remote computer.

In some embodiments, the fetching and the actuating of the stub and the modification of the copy of the object is initiated by an operator of the remote computer.

In the context of some embodiments of the present disclosure, by way of example and without limiting, terms such as ‘operating’ or ‘executing’ imply also capabilities, such as ‘operable’ or ‘executable’, respectively.

Conjugated terms such as, by way of example, ‘a thing property’ implies a property of the thing, unless otherwise clearly evident from the context thereof.

The terms ‘processor’ or ‘computer’, or system thereof, are used herein as ordinary context of the art, such as a general purpose processor or a micro-processor, RISC processor, or DSP, possibly comprising additional elements such as memory or communication ports. Optionally or additionally, the terms ‘processor’ or ‘computer’ or derivatives thereof denote an apparatus that is capable of carrying out a provided or an incorporated program and/or is capable of controlling and/or accessing data storage apparatus and/or other apparatus such as input and output ports. The terms ‘processor’ or ‘computer’ denote also a plurality of processors or computers connected, and/or linked and/or otherwise communicating, possibly sharing one or more other resources such as a memory.

The terms ‘software’, ‘program’, ‘software procedure’ or ‘procedure’ or ‘software code’ or ‘code’ or ‘application’ may be used interchangeably according to the context thereof, and denote one or more instructions or directives or circuitry for performing a sequence of operations that generally represent an algorithm and/or other process or method. The program is stored in or on a medium such as RAM, ROM, or disk, or embedded in a circuitry accessible and executable by an apparatus such as a processor or other circuitry.

The processor and program may constitute the same apparatus, at least partially, such as an array of electronic gates, such as FPGA or ASIC, designed to perform a programmed sequence of operations, optionally comprising or linked with a processor or other circuitry.

The term computerized apparatus or a computerized system or a similar term denotes an apparatus comprising one or more processors operable or operating according to one or more programs.

As used herein, without limiting, a module represents a part of a system, such as a part of a program operating or interacting with one or more other parts on the same unit or on a different unit, or an electronic component or assembly for interacting with one or more other components.

As used herein, without limiting, a process represents a collection of operations for achieving a certain objective or an outcome.

As used herein, the term ‘server’ denotes a computerized apparatus providing data and/or operational service or services to one or more other apparatuses.

The term ‘configuring’ and/or ‘adapting’ for an objective, or a variation thereof, implies using at least a software and/or electronic circuit and/or auxiliary apparatus designed and/or implemented and/or operable or operative to achieve the objective.

A device storing and/or comprising a program and/or data constitutes an article of manufacture. Unless otherwise specified, the program and/or data are stored in or on a non-transitory medium.

In case electrical or electronic equipment is disclosed it is assumed that an appropriate power supply is used for the operation thereof.

The flowchart and block diagrams illustrate architecture, functionality or an operation of possible implementations of systems, methods and computer program products according to various embodiments of the present disclosed subject matter. In this regard, each block in the flowchart or block diagrams may represent a module, segment, or portion of program code, which comprises one or more executable instructions for implementing the specified logical function(s). It should also be noted that, in some alternative implementations, illustrated or described operations may occur in a different order or in combination or as concurrent operations instead of sequential operations to achieve the same or equivalent effect.

The corresponding structures, materials, acts, and equivalents of all means or step plus function elements in the claims below are intended to include any structure, material, or act for performing the function in combination with other claimed elements as specifically claimed. As used herein, the singular forms “a”, “an” and “the” are intended to include the plural forms as well, unless the context clearly indicates otherwise. It will be further understood that the terms “comprises” and/or “comprising” and/or “having” when used in this specification, specify the presence of stated features, integers, steps, operations, elements, and/or components, but do not preclude the presence or addition of one or more other features, integers, steps, operations, elements, components, and/or groups thereof.

Unless otherwise specified, the terms ‘about’ and/or ‘close’ with respect to a magnitude or a numerical value implies within an inclusive range of −25% to +25% of the respective magnitude or value.

When a range of values is recited, it is merely for convenience or brevity and includes all the possible sub-ranges as well as individual numerical values within and about the boundary of that range. Any numeric value, unless otherwise specified, includes also practical close values enabling an embodiment or a method, and integral values do not exclude fractional values. A sub-range values and practical close values should be considered as specifically disclosed values.

The terminology used herein should not be understood as limiting, unless otherwise specified, and is for the purpose of describing particular embodiments only and is not intended to be limiting of the disclosed subject matter. While certain embodiments of the disclosed subject matter have been illustrated and described, it will be clear that the disclosure is not limited to the embodiments described herein. Numerous modifications, changes, variations, substitutions and equivalents are not precluded.

1. A method for handling data of a computerized system at a remote computer linked to the computerized system, the method comprising:
subject to applying an at least one rule:
fetching from the computerized system to the remote computer a stub of an object of the computerized system generated according to the location of the object;
actuating the stub, thereby downloading a copy of the object from the computerized system to the remote computer; and
consequent to a modification of the copy of the object in the remote computer, updating the object in the computerized system according the modification.

2. The method according to claim 1, wherein the method is facilitated by a program installed in the remote computer.

3. The method according to claim 1, wherein the stub comprises at least a part of metadata of the object of the computerized system.

4. The method according to claim 1, wherein the at least one rule is based on metadata of the object of the computerized system.

5. The method according to claim 1, wherein subject to the at least one rule fetching the stub is disabled and thus actuating the stub and updating the object in the computerized system consequent to the modification of the copy of the object are omitted.

6. The method according to claim 1, wherein subject to the at least one rule actuating the stub is disabled and thus updating the object in the computerized system consequent to the modification of the copy of the object is omitted.

7. The method according to claim 1, wherein subject to the at least one rule the modification of the copy of the object is disabled and thus updating the object in the computerized system omitted.

8. The method according to claim 1, wherein the at least one rule is installed in the remote computer.

9. The method according to claim 1, wherein the applying of the at least one rule is carried out by the program installed in the remote computer.

10. The method according to claim 1, wherein the at least one rule is installed in the computerized system.

11. The method according to claim 1, wherein the applying of the at least one rule is facilitated by the program installed in the remote computer.

12. The method according to claim 1, wherein consequent to updating the object in the computerized system the copy of the object is discarded from the remote computer.

13. The method according to claim 1, wherein the fetching and the actuating of the stub and the modification of the copy of the object is initiated by an operator of the remote computer.
